(19) United States
(12) Patent Application Publication
(10) Pub. No.: US 2004/0054741 A1
(43) Pub. Date: Mar. 18, 2004

(54) System and method for automatically limiting unwanted and/or unsolicited communication through verification

(75) Inventors: Stanley Weatherby, Romney, WV (US); Steven Salotto, Stone Harbor, NJ (US)

Correspondence Address: GREENBERG-TRAURIG, 1750 TYSONS BOULEVARD, 12TH FLOOR, MCLEAN, VA, 22102, US

(73) Assignee: Mailport25, Inc., Annapolis, MD (US)

(21) Appl. No.: 10/462,838

(22) Filed: Jun. 17, 2003

Related U.S. Application Data
(60) Provisional application No. 60/388,736, filed on Jun. 17, 2002.
(60) Provisional application No. 60/478,833, filed on Jun. 17, 2003.

(51) Int. Cl. G06F 15/16

(52) U.S. Cl. 709/206

(57) ABSTRACT

A system and method for controlling unwanted and unsolicited communications, including E-mail, through verification. The invention preferably generates a letter of introduction or other such communication to a sender, which includes instructions facilitating validation of the sender's identity. A preferred embodiment of the invention, directed toward controlling unsolicited commercial E-mail (UCE), commonly known as “spam,” is described herein.

This application claims priority from Provisional U.S. patent application Ser. No. 60/388,736, filed Jun. 17, 2002, which is hereby incorporated by reference in its entirety. This application also claims priority from and is related to the U.S. Provisional Patent Application Serial No. ______, filed on even date herewith, entitled “Unsolicited Communication Control Apparatus” by the inventors hereto.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates generally to the field electronic communication, and more specifically provides a system and methods for restricting unsolicited communications.

### BACKGROUND OF THE INVENTION

The Internet has rapidly developed into a core means through which business is conducted, and even though which members of society interact. From large corporations designing and implementing vast websites, to Mom and Dad having a family website where information about the next family reunion is posted, to Doctors' offices which have online healthcare and appointment information, the Internet is facilitating societal interaction and communication at a new scale. As part of the communications explosion, electronic mail, or E-mail, has become one of the standard business and consumer communication methods, but unsolicited commercial E-mail (“UCE”), commonly referred to as “spam”, is rapidly putting a damper on people's willingness to use E-mail. UCE has grown at an uncontrollable rate, making the review and transmission of E-mail intolerable, when it should be enjoyable and efficient.

Many UCE senders view UCE distribution as a low-cost means through which a product or service can be advertised. However, the UCE senders'perspective is skewed. While UCE is relatively low cost for the sender, UCE creates costs for recipients, their employers, and even Internet service providers. From lost worker productivity, to increased bandwidth and computational requirements, to increased support costs, UCE is, in fact, a costly distribution means when viewed from a societal perspective.

In fact, the cost of UCE to society goes beyond simple financial costs. For example, children and adults are exposed to pornography and other content which is inappropriate, undesirable, or even offensive.

Some have attempted a legislative solution to the growing UCE problem, but legislation only effects those who are physically within a country's jurisdiction, and only when they are readily identifiable. By way of example, without intending to limit the present invention, many UCE distributors are located outside the United States, thus they are not impacted by United States laws. Furthermore, many UCE distributors make it difficult to identify the true sender of an E-mail message, thereby making it difficult, if not impossible, to prosecute the UCE distributor.

Given the limited effectiveness of legislative efforts, several companies have developed content filtering software in an attempt to combat UCE. However, content filtering poses problems for end users in that it frequently blocks legitimate E-mail when certain words or phrases are contained therein, or where the sender's E-mail address is similar to that of previous UCE. Furthermore, content filtering does not give the end user any significant control over incoming message processing, nor does it allow different levels of filtering based on individual user preferences.

Others in the prior art have implemented Internet-based monitoring techniques in an effort to combat UCE. For example, U.S. Pat. No. 5,999,932, the teachings of which are incorporated herein in their entirety, teaches posting monitored E-mail addresses at various locations around the Internet, in places where UCE distributors look for E-mail addresses. When a UCE distributor sends an E-mail to one of the E-mail addresses, that E-mail is added to a system-wide block list, and all additional copies of the E-mail are rejected or deleted by the system.

Still others have implemented systems which utilize feedback from actual users to determine when a message is UCE. For example, Cloud Mark allows participants in its service to mark an E-mail message as UCE. An identifier, or “fingerprint” is then generated based on E-mail message attributes, and this fingerprint is distributed to software running on other participants' computers. The software automatically rejects or deletes any incoming messages matching the fingerprint. Unfortunately, the fingerprint technique is not sophisticated enough to accurately and consistently distinguish among innocent messages and UCE.

### SUMMARY OF THE INVENTION

Effective systems and methods for controlling UCE are needed which are scalable enough to change filtering methods with simple changes to configuration settings, which give users control over their E-mail, which do not block legitimate E-mail, and which can adapt to any E-mail or other communications platform through superior integration features, taking the complexity out of such an integration for a corporation or other deployer. Accordingly, the present invention is directed to a system and method for controlling unsolicited communications that substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages, and in accordance with the purpose of a preferred embodiment of the present invention as embodied and broadly described, in one aspect of the present invention there is provided a method of sending and receiving E-mail and an apparatus for sender and/or recipient E-mail verification through an automated and manual process which eliminates UCE.

In another aspect of the present invention there is provided a system and method of automatically learning new users on a current E-mail System and creating users and passwords through the Simple Mail Transport Protocol (“SMTP”) verify (“VRFY”) command. SMTP is an Internet standard which facilitates E-mail distribution, and is commonly known in the art.

In another aspect of the present invention, E-mail messages and sender identities may be authenticated using one or more message identifiers embedded within a message's SMTP header by transmitting such information to a sending server and requesting verification that a message with such header information was issued by the server, and that the sender is a valid user on the sending system. Such authentication may also be performed using the SMTP verify command.

In still another aspect of the present invention, there is provided a method of requesting that the sender of an E-mail message reply to an automated response by clicking on a link within the body of the automated response, or cutting and pasting code in the Subject line of the automated response.

In yet another aspect of the present invention, there is provided a system and method of requesting that the sender of the originating E-mail message reply to an automated response method by typing a unique code into an HyperText Markup Language (“HTML”) formatted message and clicking on a “Submit” button, which sends a specially formatted message containing the unique code to the recipient's E-mail server.

Another aspect of the present invention is providing a method through which the sender of an E-mail message is requested to click on a link within the body of an automated response or otherwise visit the World Wide Web site associated with such a link, wherein the link takes the sender to an HTML web page and requests that the sender click on an image map coordinate.

Still another aspect of the present invention is providing a method in which a parent or systems administrator can verify individual E-mails and/or specific sender E-mail addresses which should be explicitly blocked or allowed, such that a child or user is only exposed to desired messages.

In another aspect of the present invention, the system and methods of the present invention can be implemented in a stand-alone device or system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention, are incorporated in, and constitute a part of this specification, illustrate embodiments of the invention, and together with the description serve to explain the principles of the invention.

In the drawings:

FIG. 1 is a flow chart illustrating logic preferably implemented as part of an E-mail monitoring embodiment of the present invention which is especially useful in a corporate or Internet service provider setting.

FIG. 2 is a flow chart illustrating logic preferably implemented as part of an E-mail monitoring embodiment of the present invention through which a parent or systems administrator can exercise control over E-mail delivery to specific users.

FIG. 3 is a block diagram illustrating a preferred stand-alone, appliance based embodiment incorporating aspects of the present invention.

### DETAILED DESCRIPTION OF THE PREFERRED EMBODIMENT

Reference will now be made in detail to the preferred embodiments of the present invention, examples of which are illustrated in the accompanying drawings. While the embodiment described herein is directed to a system and methods for monitoring and controlling unsolicited commercial E-mail, it should be apparent to one skilled in the art that the system and methods have application in other communications media as well. By way of example, without intending to limit the present invention, the present invention may be adapted for use in limiting telephone call access to avoid the use of automated dialers and other unsolicited telephone marketing.

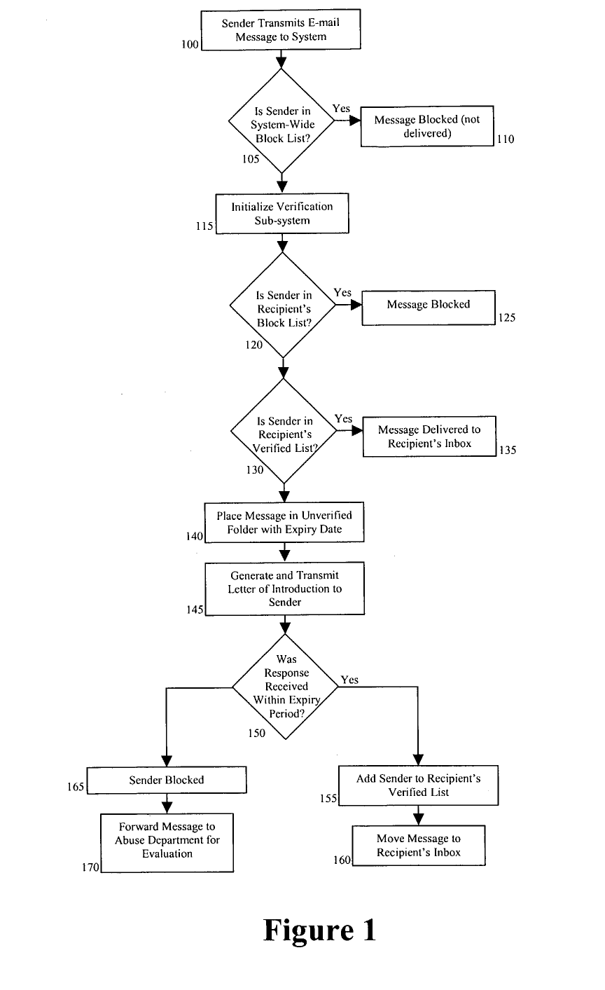

FIG. 1 is a flow chart illustrating logic preferably implemented as part of an E-mail monitoring embodiment of the present invention which is especially useful in a corporate or Internet service provider setting. While FIG. 1 represents what is believed to be an optimal process, it should be apparent to one skilled in the art that individual steps of the process need not be performed in the order described below, and that alternative ordering can be substituted therefor without departing from the spirit or the scope of the present invention.

In the preferred embodiment illustrated in FIG. 1, the logic begins when a sender transmits an E-mail message which is to a recipient on a system equipped with the present invention (Block 100). Typically, with such messages, the sender's E-mail address is entered into the From field of the SMTP header associated with the E-mail message. While the description of a preferred embodiment of the present invention focuses on the content of the From field, it should be apparent to those skilled in the art that alternative header field content could be used, including, but not limited to, the x-ReplyTo field, the sender's name, the sender's Internet Protocol (“IP”) address, or the like, without departing from the spirit or the scope of the present invention.

When an incoming message is received by a preferred embodiment of the present invention, the sender's E-mail address is preferably compared against a system-wide list of E-mail addresses which are to be blocked (Block 105). Such a list may include individual E-mail addresses, such as tom@blah.com, or E-mail addresses from entire domains, such as *@blah.com. If the sender's E-mail address is blocked, a preferred embodiment of the present invention simply discards the message (Block 110). In an alternative embodiment, a reply message may be generated indicating to the sender that their message has been blocked. Furthermore, the reply message may include special keywords, such as Unsubscribe, Remove, or the like to facilitate removal of the recipient's E-mail address from a mailing list. In still an alternative embodiment, the present invention may scan the body of a blocked E-mail message for removal instructions and, where possible, automatically perform the instructions, thereby removing the recipient from any unwanted or unauthorized mailing lists. Where the present invention cannot automatically perform the removal instructions, the present invention may, at the recipient's option, send the recipient a notification including the instructions so that the recipient can follow the instructions.

If an incoming message is not blocked by the system-wide block list, a preferred embodiment of the present invention may initialize the verification sub-system (Block 115). A preferred embodiment of the present invention checks message header integrity as part of the verification subsystem. Such checking may include, but is not limited to, locating and interpreting all appropriate header information, such as the “From:” address header. Internet RFC 821 and its appropriate revisions include generalized information pertaining to the message header standards, and is incorporated herein by reference in its entirety. If the criteria set forth by the appropriate standards are not met, the message may be rejected.

A preferred embodiment of the present invention may also compare the sender's E-mail address against the recipient's personal block list (Block 120). As with the system-wide block list described above, a recipient's block list may include E-mail addresses, such as tom@blah.com, or E-mail addresses from entire domains, such as *@blah.com. If the sender's E-mail address is blocked, a preferred embodiment of the present invention simply discards the message (Block 125). In an alternative embodiment, a reply message may be generated indicating to the sender that their message has been blocked. Furthermore, the reply message may include special keywords, such as Unsubscribe, Remove, or the like to facilitate removal of the recipient's E-mail address from a mailing list. In still an alternative embodiment, the present invention may scan the body of a blocked E-mail message for removal instructions and, where possible, automatically perform the instructions. Where the present invention cannot automatically perform the removal instructions, the present invention may, at the recipient's option, send the recipient a notification including the instructions so that the recipient can follow the instructions.

If an incoming message has not been blocked by comparison to the system-wide block list or the sender's block list, the sender's E-mail address is compared against the recipient's verified list (Block 130). If the E-mail address appears in the recipient's verified list, the message is delivered to the recipient's inbox (Block 135).

If the incoming message is not blocked, but the message is also not delivered to the recipient's inbox, a preferred embodiment of the present invention places the incoming message in an unverified folder, and assigns an expiry date to the message (Block 140). In a preferred embodiment, the present invention maintains separate unverified folders for each recipient. In an alternative embodiment, a single unverified folder may be used for all users. In still another alternative embodiment, the present invention may create separate unverified folders for different groups of users. In a preferred embodiment, the present invention allows a system administrator or other person configuring the present invention to allow or deny recipients access to E-mail in the unverified folders. Such access may be on a recipient-by-recipient basis, on a global basis, or based on other criteria, such as, but not limited to, the operating system group to which the recipient is assigned. Furthermore, the expiry period may be configured on a system-wide level, on a recipient-by-recipient basis, on a message-by-message basis, or the like.

When a message is placed in an unverified folder, the present invention preferably generates a letter of introduction, which is sent via E-mail to the sender of the original E-mail message (Block 145). The letter of introduction will preferably have at least one of the following response methods invoked within the body of the introduction letter. The methods preferably utilize an alphanumeric or numeric identification code and recipient name which identifies the E-mail address to verify and possibly other parameters, such as how long the address has been on hold status. The response methods include:

Response Method 1: An actionable link within the body of the letter of introduction.

Response Method 2: Instructions to reply to the introduction letter, substituting an identification code for the Subject, To, Carbon Copy (“CC”), or other field. Such fields may be randomly selected by the present invention at the time the letter of introduction is created to reduce the likelihood of automated systems being able to circumvent the response method.

Response Method 3: A dynamically generated image, or link to a web page containing a dynamically generated image, wherein the image contains a variety of text, including at least the E-mail address to be validated. The image and/or web page may contain at least one hyperlink, such that the sender can click on or otherwise activate the hyperlink associated with the E-mail mail address to be verified. In a preferred embodiment, such hyperlinks are mapped by coordinates within the image.

Response Method 4: An Hyper Text Markup Language (HTML) formatted message with an embedded HTML form value that requires users to type a unique code or message into a Common Gateway Interface (CGI) text field.

The present invention then waits for an appropriate response from the sender. If a response is received within the expiry period for a given message (Block 150), the sender is preferably added to the recipient's verified list (Block 155), and the subject message is moved to the recipient's inbox (Block 160) along with any other messages from the sender which are stored in the unverified folder.

While it is true that a UCE distributor could potentially produce a robot that will automatically click on any links returned within an email, to do so, the UCE distributor must use one or more non-spoofed email accounts, must receive all challenge handshake messages, and must engage in a three-way process that corroborates illegal actions. While it is difficult to stop someone intent on fooling any system, the present invention can also employ additional techniques to thwart robots. Furthermore, the verification techniques employed by the present invention require UCE distributors to give up their anonymity because the sender's IP address, domain name, and HTTP IP address are all preferably logged and reported when the sender validates with the present invention. An additional benefit of the present invention is its ability to automatically add all sender E-mail addresses whose challenge message bounces due to unknown user or other SMTP errors to the recipients'blocked list.

In a preferred embodiment, when a message from a newly verified sender is placed in the recipient's inbox, the recipient may be notified that the message is from a newly verified sender, thus allowing the recipient to easily block messages from senders who have otherwise managed to overcome the automated processes of the present invention. Such notification may take the form of, but is not limited to, applying coloring, special font effects, or the like to the message in the recipient's inbox. Alternatively, the present invention can be configured to periodically send individual recipients a tabular digest of all newly verified senders, senders for whom authentication is pending, or the like, and can allow the recipient to simply click links to verify or block the senders. The present invention also preferably allows recipients to login to their own management area and perform similar functions through a web-based user interface.

If the letter of introduction is not replied to within a certain amount of time (Block 150), the sender is automatically added to the recipient's blocked list (Block 165). In addition, the subject E-mail message, along with any other unverified E-mail messages from the sender in the unverified folder, will preferably be removed from the unverified messages folder and preferably copied to an administrative abuse department responsible for that system (Block 170) to facilitate the administrative abuse department adding the sender's E-mail address to the system-wide block list.

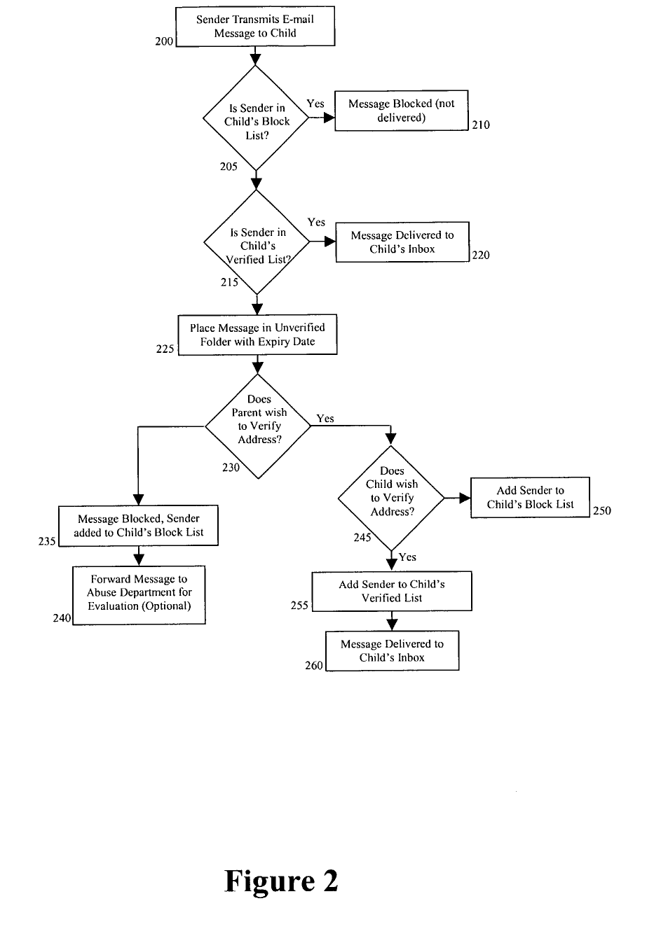

In addition to the E-mail communication verification means described above, the present invention can be adapted for additional embodiments. By way of example, without intending to limit the present invention, an embodiment of the present invention can be configured to allow parents or system administrators to verify or block mail on a per user basis or a system wide basis utilizing the following schemes. FIG. 2 is a representation of a parent/child or administrator/user embodiment. While FIG. 2 represents what is believed to be an optimal process, it should be apparent to one skilled in the art that individual steps of the process need not be performed in the order described below, and that alternative ordering can be substituted therefor without departing from the spirit or the scope of the present invention.

In the embodiment illustrated in FIG. 2, the logic begins when a sender transmits an E-mail message which is to a child recipient on a system equipped with the present invention (Block 200). Typically, with such messages, the sender's E-mail address is entered into the From field of the SMTP header associated with the E-mail message. While the description of this embodiment of the present invention focuses on the content of the From field, it should be apparent to those skilled in the art that alternative header field content could be used, including, but not limited to, the x-ReplyTo field, the sender's name, the sender's Internet Protocol (“IP”) address, or the like, without departing from the spirit or the scope of the present invention.

When an incoming message is received by a preferred embodiment of the present invention, the sender's E-mail address is preferably compared against a list of E-mail addresses which are to be blocked (Block 205). Such a list may include individual E-mail addresses, such as tom@blah.com, or E-mail addresses from entire domains, such as *@blah.com. If the sender's E-mail address is blocked, a preferred embodiment of the present invention simply discards the message (Block 210). In an alternative embodiment, a reply message may be generated indicating to the sender that their message has been blocked. Furthermore, the reply message may include special keywords, such as Unsubscribe, Remove, or the like to facilitate removal of the recipient's E-mail address from a mailing list. In still an alternative embodiment, the present invention may scan the body of a blocked E-mail message for removal instructions and, where possible, automatically perform the instructions, thereby removing the child from any unwanted or unauthorized mailing lists. Where the present invention cannot automatically perform the removal instructions, the present invention may, at the option of the child's parent, send the parent a notification including the instructions so that the recipient can follow the instructions. While reference is made to a child's parent with respect to this embodiment of the present invention, it should be apparent to one skilled in the art that an E-mail administrator, system administrator, teacher, manager, or other such authority figure can be substituted therefor without departing from the spirit or the scope of the invention. Similarly, while reference is made to a child, it should be apparent to one skilled in the art that any subordinate person could be substituted therefor without departing from the spirit or the scope of the invention.

If an incoming message is not blocked by the child's block list, a preferred embodiment of the present invention compares the sender's E-mail address to a list of E-mail addresses which have been verified and which are authorized to send E-mail to the child (Block 215). A preferred embodiment of the present invention may check message header integrity as part of this process. If the sender's E-mail address is on the child's verified list, the message is delivered to the child's inbox.

If the incoming message is not blocked, but the message is also not delivered to the recipient's inbox, a preferred embodiment of the present invention places the incoming message in an unverified folder, and assigns an expiry date to the message (Block 225) in a manner similar to that described above. The child's parent can then review the contents of the unverified folder (Block 230) and add senders to the child's blocked (Block 235) or verified lists, as desired. If the sender is blocked, the parent has the option of forwarding the message to a central abuse department for evaluation (Block 240). In the embodiment illustrated in FIG. 2, if a parent chooses to add a sender to a child's verified list, the child may still be given the option of adding the sender to the child's blocked list (Block 245). If the child so chooses, the sender's E-mail address is added to the child's block list (Block 250). If the child chooses to add the sender to the child's verified list, the sender is added (Block 255), and the message is delivered to the child's inbox.

In an alternative embodiment not illustrated in FIG. 2, when a message is placed in an unverified folder, the present invention preferably generates a letter of introduction, which is sent via E-mail to the sender of the original E-mail message, in a manner similar to that described above with respect to FIG. 1. The present invention then waits for an appropriate response from the sender. If a response is received within the expiry period for a given message, the parent is preferably notified of the response. In this alternative embodiment, the parent may be notified that the message is from a newly verified sender, thus allowing the parent to easily block messages from senders who have otherwise managed to overcome the automated processes of the present invention. Such notification may take the form of, but is not limited to, applying coloring, special font effects, or the like to the message in the parent's inbox. The parent can add the sender to the child's verified list, add the sender to the child's blocked list, or directly delegate the decision to verify or block the sender to the child. If the letter of introduction is not replied to within a certain amount of time, the sender is automatically added to the child's blocked list. In addition, the subject E-mail message, along with any other unverified E-mail messages from the sender in the unverified folder, will preferably be removed from the unverified messages folder. The removed messages may be copied to an administrative abuse department responsible for mail to the parent and/or child to facilitate the administrative abuse department adding the sender's E-mail address to a system-wide block list.

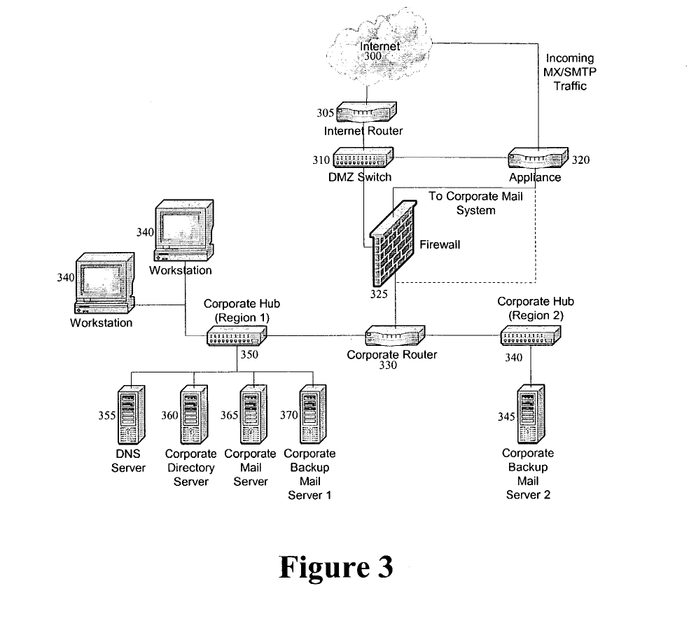

FIG. 3 illustrates the deployment of an appliance on which an embodiment of the present invention is implemented. In the embodiment illustrated in FIG. 3, a company may be connected to the Internet 300 or other communications network via router 305. In one implementation of the present invention, an up-stream router or other communications control device (not illustrated) may route all incoming MX/SMTP traffic to appliance 320. Appliance 320 can be a stand-alone computer or other hardware device capable of implementing the E-mail verification methods of the present invention. By way of example, without intending to limit the present invention, appliance 320 may be a standard, low-cost desktop computer running the LINUX® operating system, a high-end multi-processor server with large amounts of Random Access Memory (RAM) running the Microsoft® Windows 2000 Server operating system, or other combinations of hardware and/or operating systems. A preferred embodiment of appliance 320 employs a hardened Linux-based operating system, and is installed on a system with dual-CPUs, 1 GB of memory, and over 100 GB of RAID storage. All hardware and software components of appliance 320 can preferably be remotely monitored via a central Network Operations Center (“NOC”). To enhance security, a preferred embodiment of the present invention utilizes a Linux-based operating system in which only the kernel and a few utilities or services are installed, with all other services disabled. Utilities and services typically implemented on appliance 320 include, but are not limited to:

SMTP —A preferred embodiment of appliance 320 preferably runs as E-mail server or SMTP transfer agent and receives mail on TCP port 25

HTTP—Some letters of introduction include verification Uniform Resource Locators (“URLs”, and the present invention includes an HTTP server, which uses TCP port 80 for communications, to allow senders to validate themselves with the system.

HTTPS—Although designed for minimal administration, when necessary, administration can be securely performed via SSL, typically implemented on TCP port 443, and preferably only from within the corporate network.

SSH—Remote access to administrative and maintenance aspects of appliance 320 is preferably only available via SSHv3, typically implemented on TCP port 22

SNMP—Appliance 320 may also allow automated monitoring and management via SNMPv2 or SNMPv3, thereby allowing a network operations center (NOC) or the like to maintain high availability. SNMP is typically implemented on UDP port 161 and 162

Aside from those explicitly enabled, no other ports are typically available for external use. However, in alternative embodiments, appliance 320 can be configured to issue external authentication queries, such as LDAP or SecureID, for administrative purposes.

In an alternative implementation of the present invention, incoming MX/SMTP traffic may be routed directly through router 305. In such an embodiment, router 305 may pass the incoming traffic to a DMZ switch or other such device 310, which can, in turn, forward any incoming MX/SMTP traffic to appliance 320.

When appliance 320 determines that an E-mail message should not be blocked, appliance 320 can forward the message to corporate mail server 365. In one embodiment, appliance 320 may connect directly into the corporate network via corporate router 330. In an alternative embodiment, appliance 320 may connect to the corporate network via firewall 325. The later embodiment may be preferable, as it allows for stronger security policy enforcement; however, the former embodiment will reduce overall firewall workload, speed up MX/SMTP traffic flow, and should not create a significant security problem if configured properly.

In the embodiment illustrated in FIG. 3, appliance 320 can also communicate with corporate directory server 360 to learn of new users as they are added, thereby obviating the need to add such users to appliance 320 through a separate administrative step. Furthermore, outgoing E-mail messages from corporate mail server 365 may be routed through appliance 320, thereby allowing appliance 320 to automatically learn the E-mail address of any new persons with whom a user corresponds. To facilitate E-mail backups, appliance 320 can also be configured to dynamically deliver copies of incoming and/or outgoing messages to corporate backup mail server 1 (Block 370) and/or corporate backup mail server 2 (Block 345), in addition to corporate mail server 365. By way of example, without intending to limit the present invention, corporate backup mail server 2 (Block 345) may be in a location geographically distinct from corporate mail server 365, thereby facilitating E-mail access in the event of a catastrophic failure at the geographic location of corporate mail server 365.

Through the embodiment illustrated in FIG. 3, UCE is effectively never delivered to a recipient's inbox. Since the UCE is never delivered to the desktop, E-mail clients often perform better because their “Deleted” folder is not cluttered up with UCE. This also results in less memory consumption and storage requirements, both on the recipient's computer and on the corporate E-mail server. Although some recipients and senders may initially view the challenge/response system of the present invention to be somewhat burdensome, after the first few weeks of use and after the recipient's verified list is built, most find the invention to function effectively transparently.

In addition to blocking UCE, the appliance-based embodiment illustrated in FIG. 3 can also be used to block viruses. Because the operating system on appliance 320 has only limited functionality enabled, it is inherently less vulnerable to viruses, Trojan horses, or the like. Furthermore, because all MX/SMTP traffic is routed through appliance 320, appliance 320 can perform antivirus checking without bogging down corporate mail server 365 or the like.

The present invention was designed as a highly available and fully manageable anti-spam and anti-virus E-mail system, preferably implemented as an appliance. Key components unique to the present invention include, but are not limited to:

The present invention is preferably architected to operate on top of a fully transactional database. While most mail system use directory or file based mail queues, the present invention preferably stores any messages, such as, but not limited to, messages stored in unverified folders, in a database. This means that queue management is extremely simple and messages never get lost. Because a preferred embodiment of the present invention utilizes well structured states with all transactions, the present invention does not get caught in verification loops with other verification servers.

The present invention does not require user imports, directory interfaces, or passwords. Instead, the present invention allows users to login into there own management area via POP3 authentication or through LDAP, thus giving administrators piece of mind, knowing that user authentication information remains synchronized with the main mail platform.

The present invention can run within high-availability, redundant architectures with diverse Internet connections. Because the present invention uses a database, it can also perform database replication. All configuration settings and message information can be replicated via a LAN or across a wide area network.

The present invention is preferably feature rich, allowing for significant recipient personalization. By way of example, without intending to limit the present invention, such personalization can include, but is not limited to, setting the frequency with which digest information is sent.

A preferred embodiment of the present invention also natively supports email lists. Both internal lists, such as sales@company.com, as well as externally subscribed lists, can be supported by the present invention. Because internal E-mail lists such as sales@, support@, and the like are published on web pages, they are frequently targeted by UCE distributors who run simple web spiders to pick up E-mail links. As an example of the support for internal E-mail lists, without intending to limit the present invention, rather than broadcast a digest message to an entire department, the present invention allows digests to be sent to the one or more recipients who control the internal list or alias. The present invention can also perform external list detection for users that are subscribed to various Internet mailing lists. By way of example, without intending to limit the present invention, the present invention can be configured to detect incoming E-mail from mailing lists and suppresses verification messages.

While the invention has been described in detail and with reference to specific embodiments thereof, it will be apparent to those skilled in the art that various changes and modifications can be. made therein without departing from the spirit and scope thereof. Thus, it is intended that the present invention cover the modifications and variations of this invention provided they come within the scope of the appended claims and their equivalents.

What is claimed is:

1. A method for controlling distribution of unsolicited communications by processing incoming messages, comprising:
receiving into a system an incoming message from a sender to a recipient; determining the identity of the message sender;
blocking the message if the message sender identity appears on at least one blocked sender list and ceasing processing once the message has been blocked;
delivering the message if the message sender identity appears on at least one validated sender list and ceasing processing once the message has been delivered;
placing any non-blocked and non-delivered messages in an undelivered message queue;
sending a letter of introduction to the sender which requires a positive response;
adding the sender to a validated sender list associated with the recipient, delivering the message to the recipient, and ceasing processing once the message has been delivered, if the sender responds positively to the letter of introduction; and
adding the sender to a blocked sender list associated with the recipient and blocking the message if the sender does not respond positively to the letter of introduction.

2. The unsolicited communications control method of claim 1, further comprising:
evaluating a message to which the sender has not positively responded to a letter of introduction; and
adding the sender to a system-wide blocked list based on the results of the evaluation.

3. The unsolicited communications control method of claim 1, further comprising assigning an expiration period to each message placed in an undelivered message queue.

4. The unsolicited communications control method of claim 3, further comprising adding the sender to a blocked sender list associated with the recipient and blocking the message if the sender does not respond positively to the letter of introduction within the expiration period associated with the message.

5. The unsolicited communications control method of claim 1, wherein separate undelivered message queues are created for each recipient, and wherein the message is placed in a message queue for the recipient during the placing step.

6. The unsolicited communications control method of claim 1, further comprising:
allowing at least one recipient to view the contents of the at least one unverified message queue; and,
allowing at least one recipient to explicitly block or verify senders from the unverified message queue.

7. The unsolicited communications control method of claim 1, wherein the letter of introduction includes a URL which is to be followed by the sender to positively respond to the letter of introduction.

8. The unsolicited communications control method of claim 1, wherein the letter of introduction includes instructions to reply to the introduction letter, substituting an identification code in at least one of the Subject, To, or Carbon Copy (“CC”) fields to positively respond to the letter of introduction.

9. The unsolicited communications control method of claim 1, wherein the letter of introduction includes a dynamically generated image, wherein the image contains a variety of text, including at least the sender identity to be validated, wherein the image further includes at least two actionable regions, with at least one of the at least two actionable regions associated with the sender identity to be validated, whereby the sender can activate the actionable region associated with the sender identity and thereby positively respond to the letter of introduction.

10. The unsolicited communications control method of claim 1, wherein the letter of introduction includes a URL to a dynamically generated image, wherein the image contains a variety of text, including at least the sender identity to be validated, wherein the image further includes at least two actionable regions, with at least one of the at least two actionable regions associated with the sender identity to be validated, whereby the sender can activate the actionable region associated with the sender identity and thereby positively respond to the letter of introduction.

11. The unsolicited communications control method of claim 1, wherein the letter of introduction includes an HTML formatted message with an embedded HTML form value that requires the sender to type a unique code or message into a CGI text field to positively respond to the letter of introduction.

12. The unsolicited communications control method of claim 1 wherein a separate blocked sender list is maintained for each recipient.

13. The unsolicited communications control method of claim 12, wherein a system-wide blocked sender list is also maintained.

14. The unsolicited communications control method of claim 1, wherein a separate validated sender list is maintained for each recipient.

15. The unsolicited communications control method of claim 14, wherein a system-wide validated sender list is also maintained.

16. The unsolicited communications control method of claim 15, wherein all recipients on the system are automatically added to the system-wide validated sender list.

17. The unsolicited communications control method of claim 14, wherein all recipients on the system are automatically added to the validated sender list for each recipient.

18. The unsolicited communications control method of claim 1, wherein the message is an E-mail message.

19. The unsolicited communications control method of claim 1, wherein the message is an IM message.

20. The unsolicited communications control method of claim 1, wherein the message is an SMS message.

21. The unsolicited communications control method of claim 1, wherein the method is implemented on an appliance.

22. A system for controlling unsolicited communications, comprising:
at least one processor;
at least one data storage device;
at least one network card, wherein each network card facilitates communications through at least one network port;
an operating system;
at least one blocked sender list stored on the at least one data storage device;
at least one verified sender list stored on the at least one data storage device;
computer software running within the operating system capable of issuing a letter of introduction in response to a message from a sender not appearing on the at least one blocked sender list and not appearing on the at least one verified sender list; and,
at least one unverified message folder for storing messages from senders to whom letters of introduction have been issued.

23. The unsolicited communications control system of claim 22, wherein the operating system is an open source operating system.

24. The unsolicited communications control system of claim 23, wherein the operating system is Linux.

25. The unsolicited communications control system of claim 22, wherein the operating system only opens those network ports necessary to process incoming messages.

26. The unsolicited communications control system of claim 25, wherein the network card utilizes the TCP/IP communications protocol.

27. The unsolicited communications control system of claim 26, wherein network port 25 is opened by the operating system.

28. The unsolicited communications control system of claim 22, wherein the at least one data storage device includes at least one hard disk and at least one RAM module.

29. The unsolicited communications control system of claim 28, wherein the unverified message folder is stored within a database.

30. The unsolicited communications control system of claim 29, wherein the database is stored on the at least one hard disk.

31. The unsolicited communications control system of claim 30, wherein the database also contains the at least one verified sender list and the at least one blocked sender list.
